(19) United States
(12) Patent Application Publication
(10) Pub. No.: US 2010/0171010 A1
(43) Pub. Date: Jul. 8, 2010

(54) MAT BOARD CORNER SAMPLE DISPLAY AND ORGANIZING SYSTEM

(75) Inventor: Victoria Petitt, Brooklyn, NY (US)

Correspondence Address: Leason Ellis LLP, 81 Main Street, Suite 503, White Plains, NY, 10601, US

(73) Assignee: Nielsen & Bainbridge LLC, Paramus, NJ (US)

(21) Appl. No.: 12/349,459

(22) Filed: Jan. 6, 2009

(51) Int. Cl. F16M 11/02

(52) U.S. Cl. 248/176.1

(57) ABSTRACT

A matboard corner sample display system. The system includes a caddy that holds matboard corner samples such that one leg of the matboard is vertical and perpendicular to the outwardly extending second leg. The caddy includes a base, an inner vertical support attached thereto, and an outer vertical support. The inner and outer vertical supports are shaped in an arc and disposed concentrically such that a channel is formed between the inner and outer vertical support. The caddy can be shaped as a closed arc and divided into two sections that are pivotally connected by a hinge. The two sections can be separated by opening the hinge to allow a matboard corner samples in each sections to be positioned without physically interfering.

### FIELD OF THE INVENTION

The present invention generally relates to organizing and displaying framing matboard samples, and more specifically to a configurable and customizable system for organizing and displaying matboard samples.

### BACKGROUND OF THE INVENTION

A matboard is a relatively thin, flat piece of material that is used in framing to provide contrast between the article to be framed and the frame, and enhance the aesthetics of the framed piece. Matboards are typically composed of a paper-based material, but may be made from other materials and can also include a decorative covering (such as cloth or a metallic coating). They also may be provided with different surface finishes, patterns or symbols. Paper-based matboards are easy to manufacture with a variety of different face colors and with a variety of different patterns, surface ornamentation, designs and the like.

Matboards are most commonly used to decorate a framed article, such as a picture, painting, diploma or other article. Aside from aesthetics, matboards also serve a number of functional purposes, such as separating the glass from the artwork. Most of all though, if the correct size and color is chosen, matboards are able to avert the attention of the beholder inwards or towards a key element of the artwork. Accordingly, framers usually keep many different matboard samples of all different colors, textures and designs at hand so that they may appropriately match the matboard to the particular piece being framed.

With so many different matboard samples, however, it is often difficult to find exactly what matboard is preferred since numerous samples are hard to keep track of and will typically be in a state of disarray. Even if the matboard samples were once organized, they quickly deteriorate into an unorganized mess as framers will look through many different samples before finding the right one, many times not returning the samples to their proper locations. This is due in part to the job being done quickly, but it is mostly because the large number of samples require them to be horizontally or vertically stacked one on top of the other making it difficult to discern the colors of the samples in order to select a desired matboard sample or store the samples in an organized manner. Thus, having stacked, unorganized samples, it is difficult for a framer to find a desired matboard sample with the color and texture that best complements the picture.

Therefore, what is needed is a design for a matboard display system that allows the matboards to be easily and well organized and provides easy access and viewing of the matboards.

### SUMMARY OF THE INVENTION

In accordance with one aspect of the present invention, a matboard corner sample display system is provided. The system includes a caddy for holding a plurality of matboard corner samples such that the first leg of the matboard is substantially vertically and perpendicular to the second leg. The caddy includes a base that has a substantially horizontal surface and an inner vertical support attached to the base that is shaped in at least partial arc. The caddy further includes an outer vertical support that is shaped in at least a partial arc and is disposed in a substantially concentric configuration with the inner vertical support such that a channel is formed between the inner vertical support and outer vertical support to accommodate the first leg of a matboard corner sample so that the second leg of the matboard corner sample extends away from inner vertical support.

In accordance with a further aspect of the present invention, the caddy of the system can include a closed arc, such as a circle or ellipse. The caddy can be divided into two sections (e.g., halves) which are pivotally connected. Optionally, the two sections can be connected by a hinge configured to enable the two sections to be separated. Preferably, the two caddy sections can be separated so as to allow matboard corner samples in each of the two sections to be positioned anywhere in the channel of the two caddy sections without physically interfering with one another.

These and other aspects, features, and problems addressed by the invention can be further appreciated with reference to the discussion of certain embodiments and the drawings of such embodiments.

### BRIEF DESCRIPTION OF THE DRAWINGS

The foregoing and other features of the present invention will be more readily apparent from the following detailed description and drawings of illustrative embodiments of the invention in which:

FIG. 1 is a perspective view of a first embodiment of a matboard corner sample system in a configuration in accordance with the present invention;

FIG. 2 is a front view of the first embodiment of a matboard corner sample system in a further configuration in accordance with the present invention;

FIG. 3A is a top view of the first embodiment of a matboard corner sample system in a further configuration in accordance with the present invention;

FIG. 3B is a top view of the first embodiment of a matboard corner sample system in a further configuration in accordance with the present invention;

FIG. 3C is a top view of the first embodiment of a matboard corner sample system in a further configuration in accordance with the present invention;

FIG. 3D is a top view of the first embodiment of a matboard corner sample system in a further configuration in accordance with the present invention;

FIG. 4 is a perspective view of a second embodiment of a matboard corner sample system in accordance with the present invention;

FIG. 5 is a top view of the second embodiment of a matboard corner sample system in accordance with the present invention; and

FIG. 6 is a side view of the second embodiment of a matboard corner sample system in accordance with the present invention; and

FIG. 7 is a perspective view a third embodiment of a matboard corner sample system in accordance with the present invention.

### DETAILED DESCRIPTION OF THE PREFERRED EMBODIMENTS

By way of overview and introduction, the present invention provides a system and apparatus for storing and organizing framing matboards that allows for easy access and selection and a convenient display of the a range of matboard colors and textures. The display system includes a circular or arc-shaped caddy that holds one leg of the matboards in a substantially upright position in a channel and the second leg of the matboard extending radially away from the arc so as to allow the matboards to fan out around circumference of the caddy.

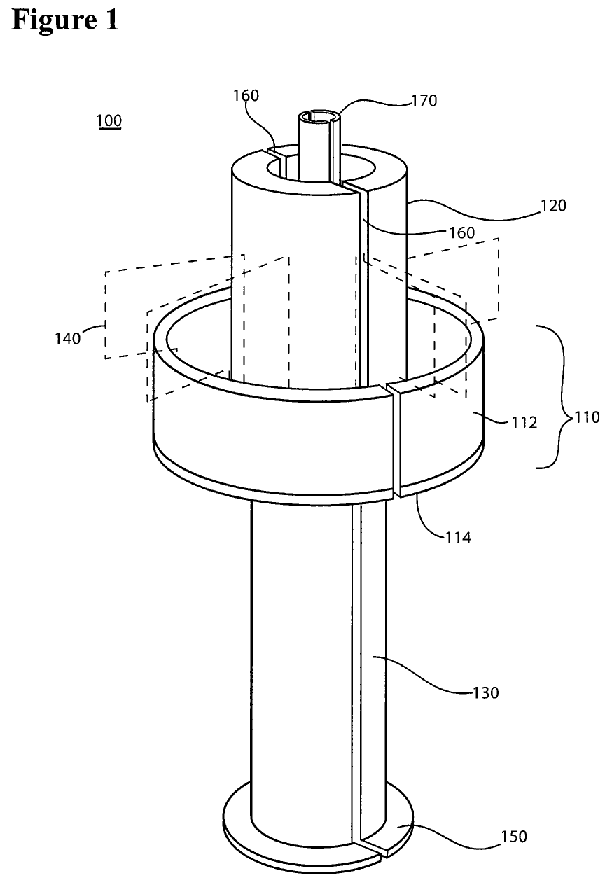

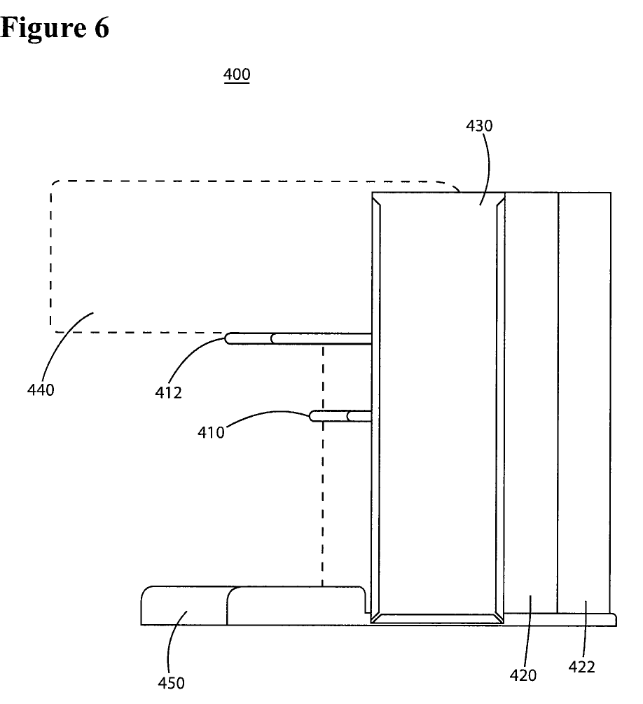

With reference to the figures, FIG. 1 is a perspective view of a first embodiment of a matboard corner sample system 100 in accordance with the present invention. The system 100 includes a circular caddy 110 having a base 114 and a sidewall 112. Disposed inside the sidewall 112 of the caddy 110 is an inner-wall 120, illustrated in FIG. 1 as a cylinder. One leg of the matboards 140 can be held between the inner-wall 120 and sidewall 112 of the caddy 110, as illustrated in FIG. 1. As discussed below with reference to FIGS. 4-6, the caddy 110 is not required to be a closed arc (e.g., a circle or ellipse), but rather can be any arc section (i.e., partial arc).

The inner-wall 120, a portion of the top surface of the base 114 and the sidewall 112 form a U-shaped channel in which a leg of the matboards 140 is retained. The distance between the inner-wall 120 and the sidewall 112 is preferably similar to the width of the leg of the matboard 140 retained therein, thus maintaining the sample matboards 140 in a substantially vertical position. In this configuration, the matboards 140 are displayed around the circumference of the caddy 110 with the other leg of the matboard 140 extending radially beyond the sidewall 112. The radially extending legs of the matboards 140 fan-out around the caddy so as to display the color and texture of each sample. It should be noted that Matboards 140 having legs of varying width can be accommodated by the system in a number of ways. The inner-wall 120 can include a non-uniform shape, such as an oval, in order to vary the distance between the sidewall 112 and the inner-wall 120, thereby accommodating matboards 140 of varying width.

The caddy 110 can be placed on a table using the base 114 as a support. Alternatively, the caddy 110 can be placed on or attached to a stand 130 and optional base 150. Thus, the caddy can be placed on the floor or elevated on a table surface. An optional center-post 170 can be used to hold display sign or other advertisement. Alternatively, the center-post 170 can be located within a hollow center of the inner-wall 120, thereby defining a further space in which to store product literature, catalogues, or other materials.

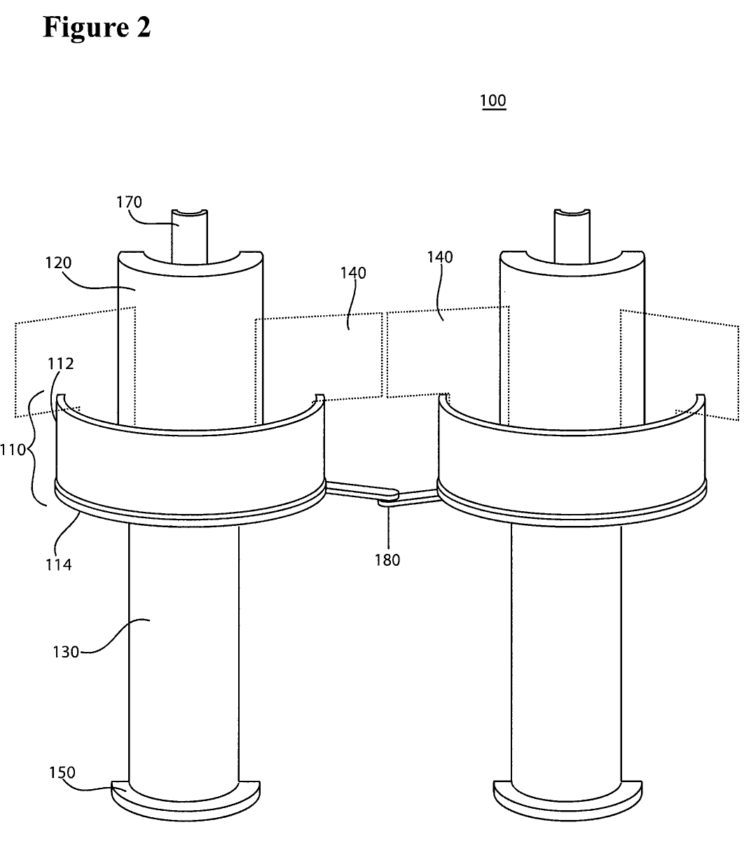

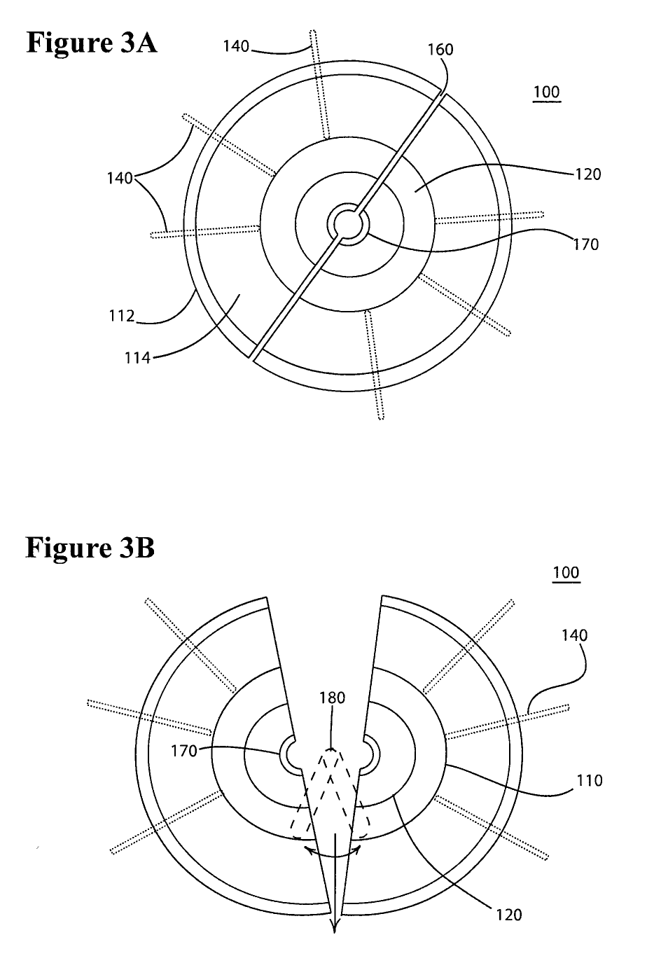

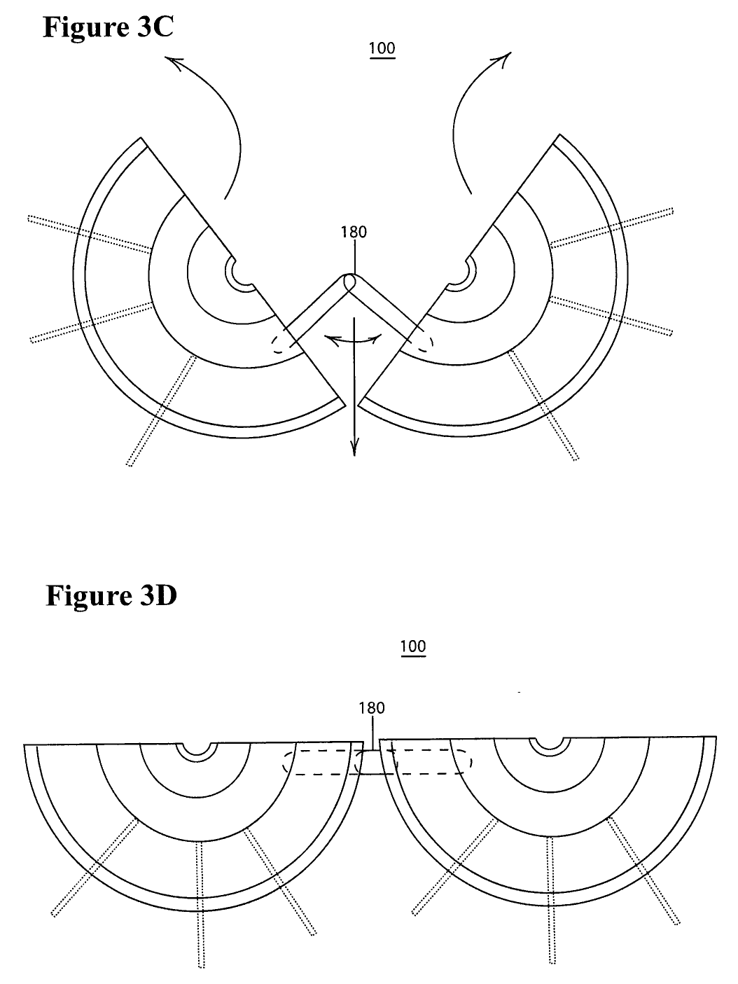

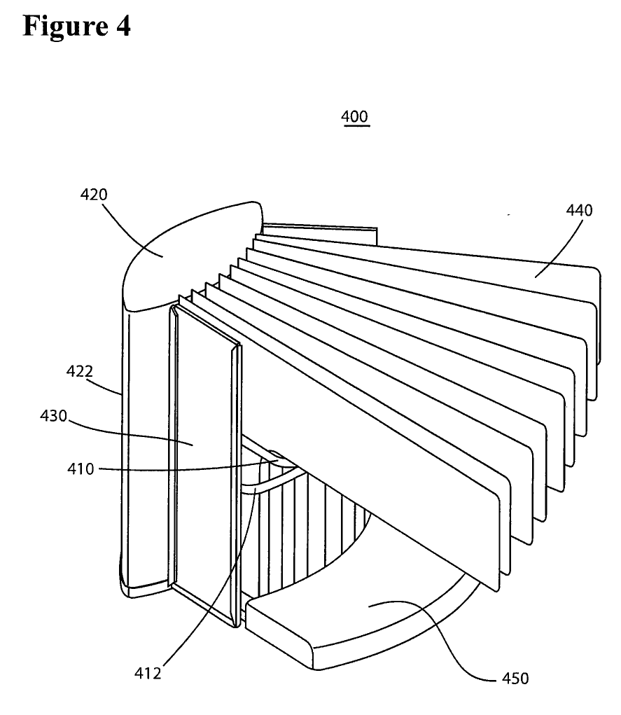

FIG. 1 further illustrates a hemispherical division 160 of the system 110 that enables the system 100 to be expanded as illustrated in FIGS. 2 and 3A-3D. FIG. 2 illustrates the system 100 of FIG. 1 in an open configuration in which the caddy 110, inner-wall 120, stand 130, and base 150 have been separated about division 160. FIG. 2 illustrates the caddy divided in half, however, it would be understood by one of ordinary skill in the art, that the caddy 110 can be divided into nearly any sectional configuration of two or more sections. The two sections of the system 100 can be attached by hinge 180, which is preferably not visible in the closed configuration of FIG. 1. The arms of hinge 180 are preferably long enough to prevent the matboards 140 retained in each hemisphere from obstructing one another. That is, when in the open configuration, the hinge 180 of system 100 provides sufficient clearance to allow a matboard 140 to be positioned at any location of one hemisphere of the caddy 110 without obstructing the movement or view of a matboard 140 in the other hemisphere of the caddy 110.

FIGS. 3A is a top view of the embodiment of the matboard corner sample system illustrated in FIG. 1 in the closed configuration. FIGS. 3B and 3C are top views of the embodiment of the matboard corner sample system of FIG. 1 as it transitions to the open configuration illustrated in FIG. 2 and FIG. 3D.

In the open configuration, the system can be abutted against any flat surface such as a wall or a table side. Optionally, the system 100 can include a mounting for hanging or affixing the system 100 to the flat surface. In a further alternative, the two halves of the system 100 can be separated (e.g., via a releasable hinge or by excluding the hinge 180) and positioned independently.

While FIG. 1 illustrates one embodiment of the present invention that utilizes a circular caddy 110, FIG. 4 illustrates a further embodiment of a matboard corner sample system 400 having a caddy that is an arc section (i.e., circular section).

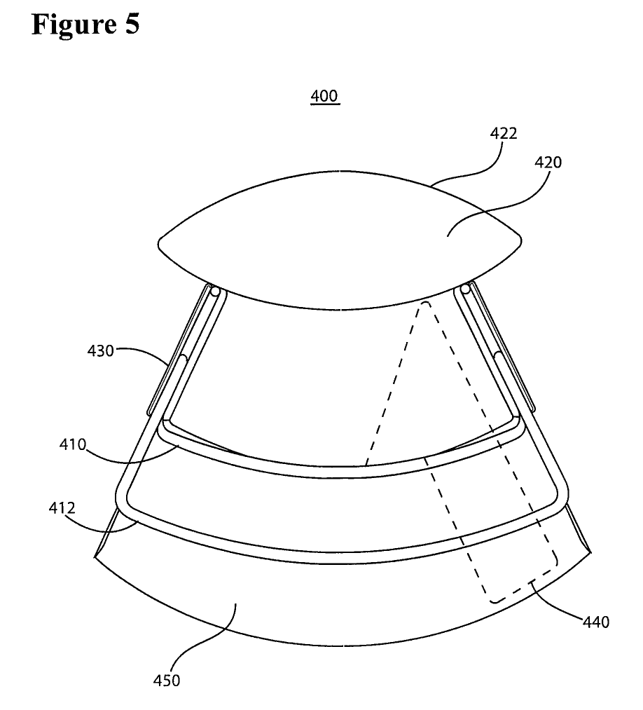

In accordance with the embodiment illustrated in FIGS. 4-6, matboards 440 are retained between an inner support 420 and an outer support 410. The outer support 410 can include a circular wall, similar to outer wall 112, or a guide rail (e.g., bar or wire) as illustrated in FIG. 4. Additional outer supports 412 can be included to provide additional support and guide matboards 440 as they are moved within the caddy display. For example, as illustrated in FIG. 5, the vertical leg of the matboard 440 is retained between inner support 420 and outer support 410, and the horizontal leg of matboard 440 (i.e., the radially extending leg of matboard 440) is supported vertically by outer support 412 so as to support the weight of the matboard 440 extending radially away from the inner support 420. The vertical leg of matboard 440 extends radially beyond the outer support 410 so as to fan-out and display the texture and color of the matboard 440.

The system 400 can include a base 450 and sidewalls 430 which add structural support and rigidity to the system 400. Additionally, the visible surfaces of the base 450, sidewalls 430, and outer surface 422 of the inner support 420 can be utilized as marketing space. For example, advertisements for the framing company or matboard company can be placed on these surfaces to increase brand awareness. Alternatively, promotions, such as sales and specials, can be advertised on these surfaces.

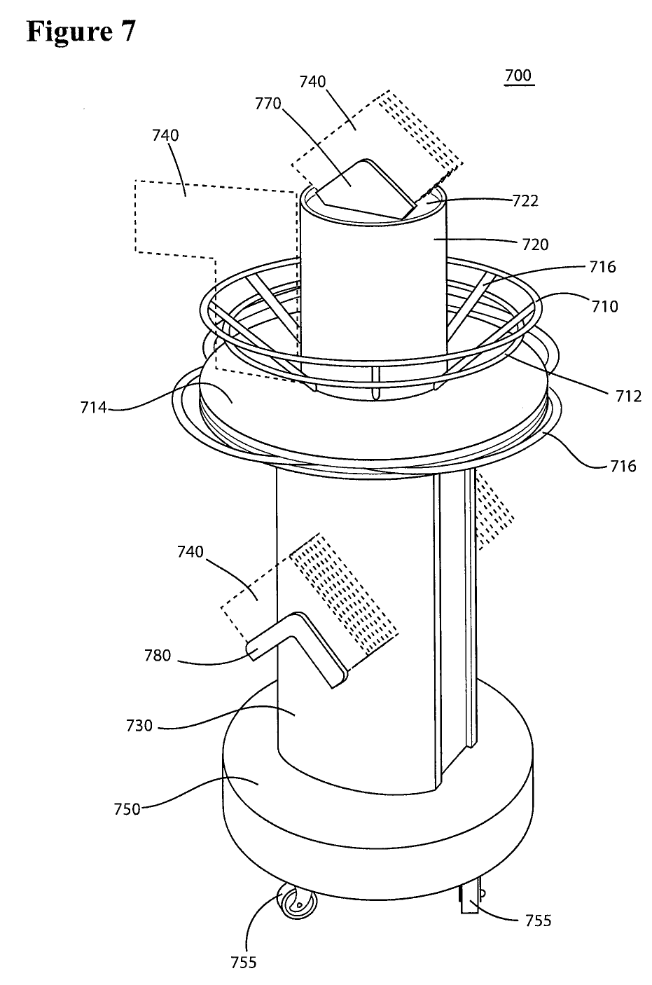

FIG. 7 illustrates yet a further embodiment of the present invention that includes features of a conventional matboard display system. The system 700 includes a caddy having a caddy base 714 and outer support 710 and 712 around an inner wall 720. Matboards 740 are retained between the outer supports 710 and 712 and the inner wall 720. Support bars 716 affix the outer supports 710 and 712 to the caddy base 714 or inner wall 720. If the support bars 716 extend from the caddy base 714 or inner wall 720, the support bars 716 can be used to group and further organize the matboards 740.

The caddy base 714 can be mounted to a stand 730. The stand 720 can include a variety of shapes and designs. The stand 730 can include a base 750 that is optionally affixed to wheels 755 for ease of transport and movement. Additionally, a decorative carrying handle 716 can be mounted to the caddy base 714.

Additional matboards can be displayed using L-brackets mounted to the system 700. For example L-bracket 770 is mounted to the top 722 of inner wall 720. In another example, L-bracket 780 is mounted to the stand 730. The additional L-brackets allow for storage and display of additional matboards and can be designed to accommodate and enhance the organization of the matboards 740 displayed in the caddy.

While the invention has been particularly shown and described with reference to preferred embodiments thereof, it will be understood by those skilled in the art that various changes in form and details may be made therein without departing from the spirit and scope of the invention.

We claim:

1. A matboard corner sample display system, comprising:
a caddy for holding a plurality of matboard corner samples, each matboard corner sample having a first and second leg, the first leg being disposed approximately perpendicular to the second leg, the caddy having a base with at least one substantially horizontal surface;
an inner vertical support attached to the base and shaped in a first at least partial arc; and
an outer vertical support being shaped in a second at least partial arc and disposed in a substantially concentric configuration about the inner vertical support so as to form a channel configured to accommodate the first leg of a matboard corner sample such that the second leg of the matboard corner sample extends away from inner vertical support.

2. The system of claim 1, wherein the inner vertical support is a closed arc and the outer vertical support is a closed arc.

3. The system of claim 2, wherein the caddy is divided into a first portion and a second portion, the first caddy portion having a first base portion, a first vertical support portion, and a first outer vertical support portion and the second caddy portion having a second base portion, a second vertical support portion, and a second outer vertical support portion, the system further comprising at least one hinge rotationally connecting the first and second caddy portions and configured to enable the first caddy portion to separate from the second caddy portion.

4. The system of claim 3, wherein the hinge includes a first and second arm, each hinge arm having a first and second end, the first end of the first arm being pivotally connected to the first end of the second arm, the second end of the first arm being pivotally connected to the first caddy section, and the second end of the second arm being pivotally connected to the second caddy section.

5. The system of claim 4, wherein, in an open configuration, first caddy portion and second caddy portion are separated by a sufficient distance so as to enable a first matboard disposed within the first caddy portion and second matboard disposed within the second caddy portion to be positioned within the channel absent physical interference between the first and second matboard.

6. The system of claim 1, further comprising a stand, wherein the caddy is disposed on the stand.

7. The system of claim 6, wherein the caddy is removably disposed on the stand.

8. The system of claim 1, wherein the outer vertical support includes a wire.

9. The system of claim 1, wherein the outer vertical support is attached to the inner vertical support of the caddy.

10. A caddy for holding a plurality of matboard corner samples, each matboard corner sample having a first and second leg, the caddy comprising:
a base; and
a channel formed in at least a partial arc and disposed on the base, the channel being configured to accommodate the first leg of a matboard corner sample such that the second leg of the matboard corner sample extends away from inner vertical support.

11. The caddy of claim 10, wherein the channel is formed in the base.

12. The caddy of claim 10, wherein the channel is formed by at least a portion of a surface of the base, an inner support formed in a first at least partial arc, and an outer support being formed in a second at least partial arc and disposed in a substantially concentric configuration about the inner support.

13. The caddy of claim 11, wherein the channel is a closed arc.

14. The caddy of claim 13, wherein the caddy is divided into a first and second caddy portions so as to divide the base and the channel along a vertical plane, the caddy further comprising at least one hinge rotationally connecting the first and second caddy portion and configured to enable the first caddy portion to separate from the second caddy portion such that the caddy is in an open configuration.

15. The caddy of claim 14, wherein the hinge includes a first and second arm, each hinge arm having a first and second end, the first end of the first arm being pivotally connected to the first end of the second arm, the second end of the first arm being pivotally connected to the first caddy section, and the second end of the second arm being pivotally connected to the second caddy section.

16. The caddy of claim 14, wherein, in the open configuration, the first caddy portion and the second caddy portion are separated by a sufficient distance so as to enable a first matboard disposed within the first caddy portion and a second matboard disposed within the second caddy portion to be positioned within the channel absent physical interference between the first and second matboard.

17. The caddy of claim 10, wherein the channel is formed by at least a portion of the base, an inner guide rail, and an outer guide rail.
